(19) United States
(12) Patent Application Publication
(10) Pub. No.: US 2011/0188004 A1
(43) Pub. Date: Aug. 4, 2011

(54) PROJECTION-TYPE IMAGE DISPLAY APPARATUS

(75) Inventors: Makoto MAEDA, Osaka-shi (JP); Hideyuki KANAYAMA, Uji-shi (JP); Takehiko ASANO, Toyonaka-shi (JP); Toru KIRIMURA, Tsushima-shi (JP); Satohiro OZAWA, Nishinomiya-shi (JP); Masanori TANINA, Suita-shi (JP); Tatsuya HIROOKA, Adachi-ku (JP); Masashi ODA, Sakai-shi (JP); Shinya MATSUMOTO, Uji-shi (JP)

(73) Assignee: SANYO ELECTRIC CO., LTD., Moriguchi-shi (JP)

(21) Appl. No.: 13/013,080

(22) Filed: Jan. 25, 2011

(30) Foreign Application Priority Data
Jan. 29, 2010 (JP) 2010-017890

(51) Int. Cl. G03B 21/16; G03B 21/20; G03B 21/28

(52) U.S. Cl. 353/43; 353/119; 353/52; 353/98

(57) ABSTRACT

A projection-type image display apparatus includes an imaging light generation portion which generates imaging light, a housing which stores the imaging light generation portion, and a passage region provided in the housing, through which the imaging light emitted from the imaging light generation portion passes. The housing has a movable portion of which dimension in at least one direction varies, and the passage region is stored in the housing by means of the movable portion while imaging light is not projected.

This nonprovisional application is based on Japanese Patent Application No. 2010-017890 filed with the Japan Patent Office on Jan. 29, 2010, the entire contents of which are hereby incorporated by reference.

### BACKGROUND OF THE INVENTION

1. Field of the Invention

The present invention relates to a small-sized projection-type image display apparatus and specifically to a projection-type image display apparatus as large as a PET bottle, which is placed on a desk, with a desktop serving as a screen.

2. Description of the Related Art

A projection-type image display apparatus (a projector) of a type for projecting an image on a screen, a wall surface or the like has conventionally been general. In contrast, a projector of a type placed on a desk or the like, for projecting an image on a desk surface, has recently been proposed. In this case, however, since a distance between a position of emission of projected light and a projection surface (a desk surface) is short, a projection optical system should be elaborated as compared to the projector of a type for projecting an image on a screen, a wall surface or the like.

For example, a technique for decreasing a distance between the position of emission of projected light and the projection surface by turning back an optical path of the projected light with the use of a plurality of plane mirrors is available. In addition, a technique for decreasing a distance between the position of emission of projected light and the projection surface by using a convex mirror or a concave mirror as the last optical member in a projection optical system including mirrors is available.

With further reduction in size, however, it is expected that a user will more frequently carry a projection-type image display apparatus by hand or in a bag to a place where it is to be used. On the other hand, high precision is required in attachment of the projection optical system (in particular, a mirror) in the projection-type image display apparatus as above. Therefore, while the projection-type image display apparatus is not in use, specifically while it is carried, protection thereof is desired such that the projection optical system is not touched or the projection optical system is not flawed or made dirty.

### SUMMARY OF THE INVENTION

In order to solve the above-described problems, a projection-type image display apparatus according to the present invention has the following features. Namely, the projection-type image display apparatus (a projection-type image display apparatus 100) which projects imaging light on a projection surface includes an imaging light generation portion (an imaging light generation portion 140) which generates the imaging light, a housing (a housing 101) which stores the imaging light generation portion, and a passage region (for example, a projection window 113) provided in the housing, through which the imaging light emitted from the imaging light generation portion passes. The housing has a movable portion (for example, a slide portion 190) of which dimension in at least one direction (for example, a direction of a Z axis) varies. It is summarized that the passage region is stored in the housing by means of the movable portion while the imaging light is not projected.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a front view showing a construction of a projection-type image display apparatus according to a first embodiment.

FIG. 2 is a side view showing the construction of the projection-type image display apparatus according to the first embodiment.

FIG. 3A is a left perspective view showing an external construction of the projection-type image display apparatus according to the first embodiment.

FIG. 3B is a right perspective view showing the external construction of the projection-type image display apparatus according to the first embodiment.

FIG. 4 is a diagram showing an internal construction when the projection-type image display apparatus according to the first embodiment projects imaging light.

FIG. 5 is a diagram showing an internal construction when the projection-type image display apparatus according to the first embodiment is stored.

FIG. 6 is a diagram showing an internal construction when a projection-type image display apparatus according to a first variation of the first embodiment projects imaging light.

FIG. 7 is a diagram showing an internal construction when the projection-type image display apparatus according to the first variation of the first embodiment is stored.

FIG. 8 is a diagram showing an internal construction when a projection-type image display apparatus according to a second variation of the first embodiment projects imaging light.

FIG. 9 is a diagram showing an internal construction when the projection-type image display apparatus according to the second variation of the first embodiment is stored.

FIG. 10 is a diagram showing an internal construction when a projection-type image display apparatus according to a third variation of the first embodiment projects imaging light.

FIG. 11 is a diagram showing an internal construction when the projection-type image display apparatus according to the third variation of the first embodiment is stored.

FIG. 12 is a front view showing a construction of a projection-type image display apparatus according to a second embodiment.

FIG. 13A is a diagram illustrating a floor surface projection mode of the projection-type image display apparatus according to the second embodiment.

FIG. 13B is a diagram illustrating a wall surface projection mode of the projection-type image display apparatus according to the second embodiment.

FIG. 14A is a diagram illustrating a floor surface projection mode of a projection-type image display apparatus according to a first variation of the second embodiment.

FIG. 14B is a diagram illustrating a wall surface projection mode of the projection-type image display apparatus according to the first variation of the second embodiment.

FIG. 15A is a diagram illustrating a floor surface projection mode of a projection-type image display apparatus according to a second variation of the second embodiment.

FIG. 15B is a diagram illustrating a floor surface projection mode of the projection-type image display apparatus according to the second variation of the second embodiment.

FIG. 16 is a diagram illustrating a projection mode of a projection-type image display apparatus according to a third variation of the second embodiment.

### DESCRIPTION OF THE PREFERRED EMBODIMENTS

A projection-type image display apparatus according to an embodiment of the present invention will be described hereinafter with reference to the drawings. In the drawings below, the same or similar elements have the same or similar reference characters allotted.

It is noted that the drawings are schematic and a ratio or the like of each dimension is different from actuality. Therefore, a specific dimension or the like should be determined taking into account the description below. In addition, the drawings naturally include portions different in relation in dimension or ratio.

[Outlines of Embodiment]

The projection-type image display apparatus according to the present embodiment includes an imaging light generation portion for generating imaging light and a mirror (an aspherical mirror) for reflecting the imaging light emitted from the imaging light generation portion toward a projection surface. In addition, the projection-type image display apparatus includes an electric power supply portion (a battery portion) for supplying electric power to the imaging light generation portion, and this electric power supply portion is provided at a position as distant as possible from the mirror. Specifically, when the mirror is provided in an uppermost portion, the electric power supply portion is provided in a lowermost portion. Moreover, the projection-type image display apparatus further includes a cooling portion for cooling the imaging light generation portion, and this cooling portion is also provided at a position as distant as possible from the mirror. Specifically, the cooling portion is provided at a position slightly above the electric power supply portion.

Further, the projection-type image display apparatus according to the present embodiment includes a housing for storing at least the imaging light generation portion and a passage region (a projection window) provided in an upper portion of the housing, through which the imaging light is projected. This housing has a movable portion (a slide portion) of which dimension in at least one direction (a direction of the Z axis) varies, and while imaging light is not projected, the passage region is stored in the housing and moved to a hidden position by means of the movable portion.

Furthermore, the projection-type image display apparatus according to the present embodiment includes detection means (such as an inclination sensor) for detecting a state of the apparatus itself with respect to the projection surface and control means (a control unit) for controlling a state of the imaging light in accordance with the detected state.

### First Embodiment

(Construction of Projection-Type Image Display Apparatus)

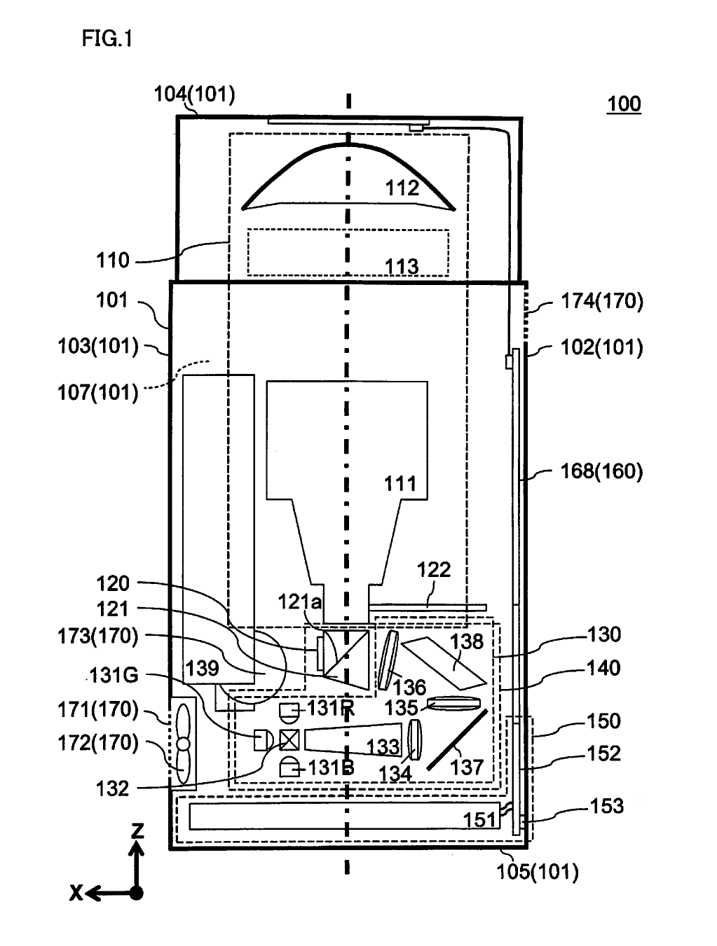

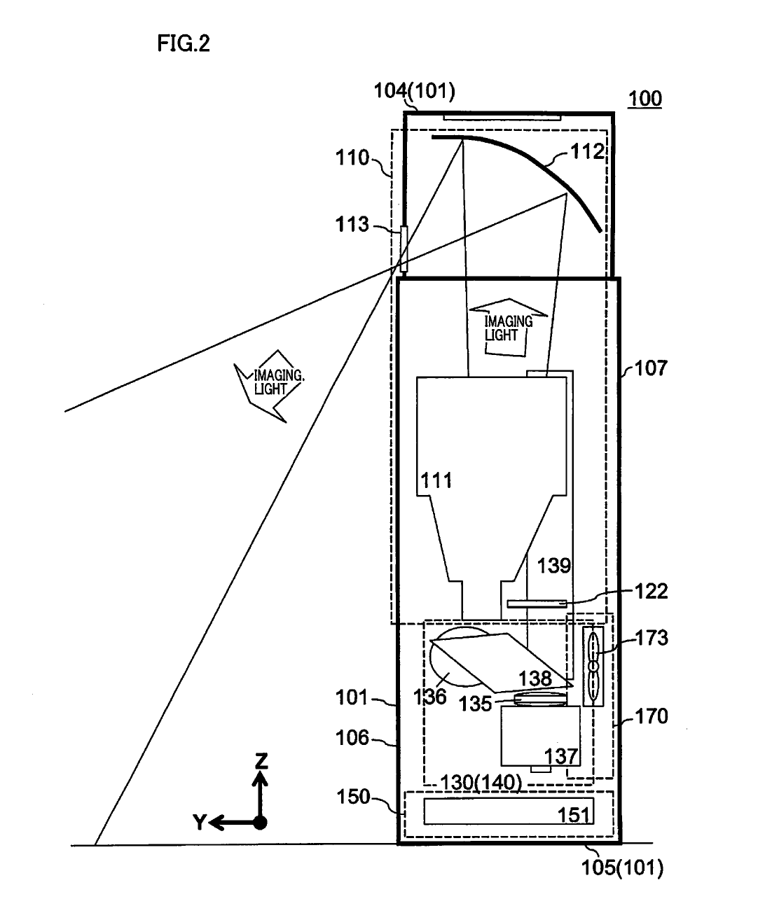

A construction of a projection-type image display apparatus according to a first embodiment will be described hereinafter with reference to the drawings. FIG. 1 is a front view showing the construction of the projection-type image display apparatus according to the first embodiment and FIG. 2 is a side view thereof.

As shown in FIG. 1, a projection-type image display apparatus 100 has a projection portion 110 constituted of a projection lens group 111 and an aspherical mirror 112, a DMD (Digital Micromirror Device) 120 serving as a light modulation element, an illumination portion 130 for irradiating DMD 120 with light, and a battery portion 150 for supplying electric power to DMD 120, an LED (Light Emitting Device) 131 implementing illumination portion 130, and the like.

In the present embodiment, projection-type image display apparatus 100 is installed with battery portion 150 being located below. A surface on which projection-type image display apparatus 100 is installed (a horizontal surface) is defined as an XY plane and a direction perpendicular to the installation surface (a vertical direction) is defined as the direction of the Z axis. A direction of an X axis is defined as a direction corresponding to a direction of width of a housing 101 of projection-type image display apparatus 100 and a direction of a Y axis is defined as a direction corresponding to a direction of depth of housing 101.

In FIG. 1, housing 101 has one side surface 102 serving as a right side surface, another side surface 103 serving as a left side surface, a top surface 104 serving as an upper surface, and a bottom surface 105 serving as a lower surface. In addition, housing 101 has a front surface 106 serving as a surface on a side where imaging light is emitted in FIG. 2 and a rear surface 107 serving as a back surface with respect to front surface 106.

Projection portion 110 has projection lens group 111 constituted of a plurality of lenses, aspherical mirror 112 implemented by an aspherical mirror having a concave surface, and a projection window 113 through which imaging light is emitted (see FIG. 2). Projection lens group 111 allows emission of the imaging light modulated by DMD 120 in the direction of the Z axis. Aspherical mirror 112 is provided above projection lens group 111 and reflects the imaging light from projection lens group 111 in a downward direction. Since aspherical mirror 112 is a concave mirror, the imaging light is once condensed and then projected as it is magnified. Projection window 113 is provided in the vicinity of a position where the imaging light is condensed. The imaging light forms an image between projection lens group 111 and aspherical mirror 112 and again forms an image at the installation surface (the XY plane in the drawing) of projection-type image display apparatus 100.

DMD 120 modulates illumination light of blue, green and red emitted from illumination portion 130 in a time-divided manner in response to an image input signal. DMD 120 is provided integrally with a prism block 121 for guiding imaging light to projection lens group 111. Prism block 121 has a surface 121a allowing passage of illumination light from illumination portion 130, totally reflecting the imaging light modulated by DMD 120, and guiding the imaging light to projection lens group 111. A DMD control circuit 122 for controlling DMD 120 is arranged in the vicinity of DMD 120. DMD control circuit 122 controls DMD 120 in accordance with an image input signal and an LED control signal.

Illumination portion 130 has LEDs 131R, 131G, 131B for emitting light of red, green and blue respectively and a plurality of optical members for combining light of red, green and blue for irradiation of DMD 120. In the present embodiment, a dichroic prism 132 is used as an optical member for combining light of red, green and blue. Distribution of a quantity of light combined by dichroic prism 132 is made uniform by a tapered rod 133. Lenses 134, 135, 136 provided in a stage subsequent to tapered rod 133 have a function to collimate light emitted from tapered rod 133 so as to form an image on DMD 120. Mirrors 137, 138 have a function to bend an optical path of the combined light in conformity with a space.

An LED control circuit 139 for controlling LED 131 is arranged in the vicinity of LED 131. LED control circuit 139 controls a quantity of light emission and light emission timing of LEDs 131R, 131G, 131B in accordance with an image input signal. In addition, LED control circuit 139 sends an LED control signal relating to the light emission quantity and the light emission timing to DMD control circuit 122. LED control circuit 139 is desirably arranged in the vicinity of LED 131 in order to make shorter a distance for wiring. Meanwhile, taking into account influence of electromagnetic waves, LED control circuit 139 is also desirably arranged as distant as possible from DMD control circuit 122. DMD 120 and illumination portion 130 are collectively referred to as an image generation portion 140.

Battery portion 150 has a battery 151 implemented by a nickel metal hydride secondary battery, a battery control circuit 152 for controlling charge and discharge of battery 151, and a power supply connector 153 connected to a commercial power supply. Battery 151 has such a shape that a dimension in the direction of the X axis or the direction of the Y axis is sufficiently greater than (at least two times as great as) the dimension in the direction of the Z axis. Battery control circuit 152 controls electric power supplied from the commercial power supply through power supply connector 153 to battery 151 and controls electric power supplied from battery 151 to image generation portion 140 (in particular, LED 131 and DMD 120). Not only a nickel metal hydride secondary battery but also a lithium ion secondary battery or a capacitor may be employed as a battery.

Broadly speaking, a control unit 160 includes DMD control circuit 122, LED control circuit 139, and a control circuit 168 for controlling overall projection-type image display apparatus 100. Specifically, control circuit 168 is arranged in a region on the side of one side surface 102 of projection portion 110 (in particular, projection lens group 111), and control circuit 168 sends a control signal to DMD control circuit 122 and LED control circuit 139 in accordance with an image input signal or the like. Though details will be described later, the image input signal is input through a connector for image signal 161, 162, a slot 163 for an SD card, a USB connector 164, and a LAN connector 165 that are connected to control circuit 168. Control circuit 168 is also connected to a power switch 166 and an operation button 167. Control circuit 168 controls overall projection-type image display apparatus 100 in response to a user's instruction through power switch 166 or operation button 167.

A cooling portion 170 is arranged in a region of projection lens group 111 on the side of another side surface 103. Specifically, an axial fan 172 provided in the vicinity of an exhaust port 171, a sirocco fan 173 for cooling LED 131, a heat sink (not shown) for cooling DMD 120 are arranged. Air for cooling projection-type image display apparatus 100 is supplied through an intake port 174 provided in an upper portion of one side surface 102, it flows through the inside of projection-type image display apparatus 100 and cools control unit 160 and image generation portion 140, and thereafter it is exhausted through exhaust port 171 provided in a lower portion of another side surface 103.

By providing intake port 174 and exhaust port 171 at positions diagonal to each other in housing 101, projection-type image display apparatus 100 can efficiently be cooled. In addition, since intake port 174 and exhaust port 171 are provided in one side surface 102 and another side surface 103 respectively, the intake and exhaust ports are not closed even when rear surface 107 is set as the installation surface. Intake port 174 is closed by the slide portion which will be described later, while projection-type image display apparatus 100 is not in use. According to this construction, introduction of dust or the like into projection-type image display apparatus 100 during storage can be prevented. It is noted that another intake port different from intake port 174 is preferably provided for sirocco fan 173.

(External Construction of Projection-Type Image Display Apparatus)

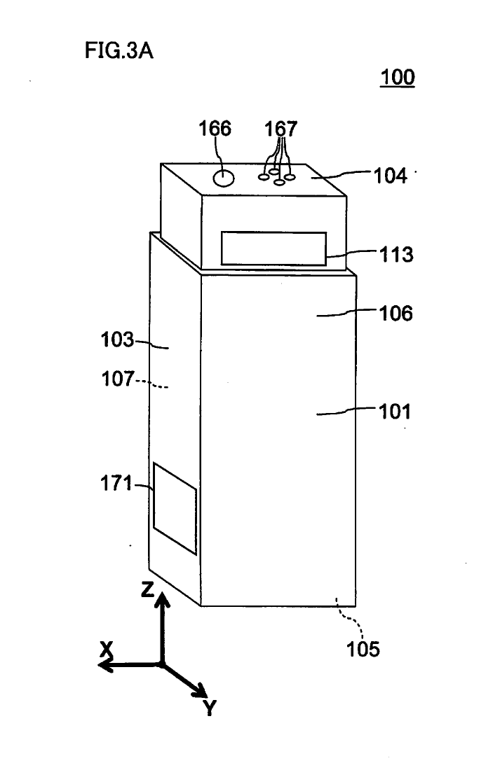

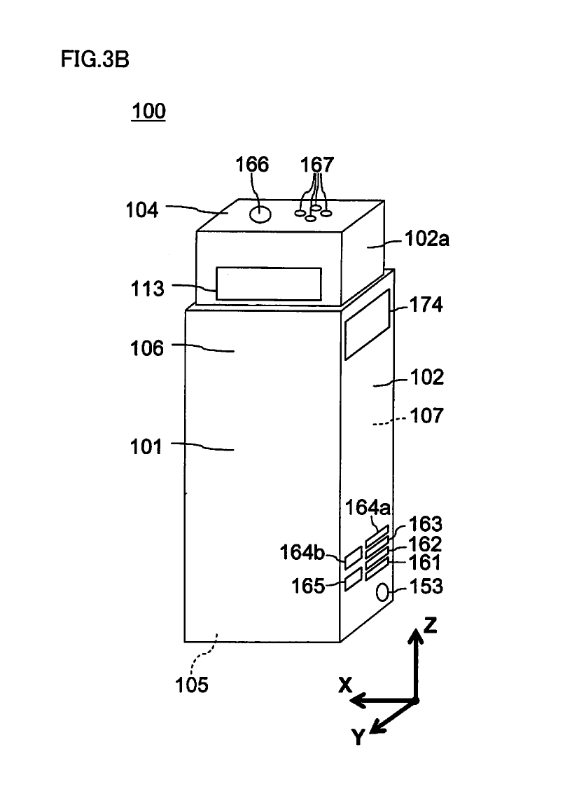

An external construction of the projection-type image display apparatus according to the first embodiment will be described hereinafter with reference to the drawings. FIGS. 3A and 3B are diagrams showing the external construction of the projection-type image display apparatus according to the first embodiment, and FIG. 3A is a left perspective view and FIG. 3B is a right perspective view.

Housing 101 has front surface 106 which is a surface on a side where imaging light is emitted and has projection window 113 arranged, and rear surface 107 arranged at a position opposed to front surface 106. In addition, housing 101 has top surface 104 set as an upper surface when projection-type image display apparatus 100 is installed to project imaging light on a desktop or on a floor surface and bottom surface 105 arranged at a position opposed to top surface 104. In projection-type image display apparatus 100 having a substantially parallelepiped shape, out of two remaining two surfaces, a surface where power supply connector 153 described above is arranged is defined as one side surface 102 and a surface arranged at a position opposed to one side surface 102 is defined as another side surface 103.

In one side surface 102, not only power supply connector 153 but also connector for image signal 161, 162 connected to an image source such as a PC (Personal Computer) or the like, slot 163 for an SD card, USB connector 164a, 164b, LAN connector 165, and the like are provided. These connectors are preferably provided in a portion of one side surface 102 close to bottom surface 105. One side surface 102 has an overlaid portion 102a stored inside during storage by means of the slide portion which will be described later. Intake port 174 arranged in one side surface 102 is preferably provided at a position where it lies over one side surface 192 of a slide portion 190 when slide portion 190 is stored.

Exhaust port 171 is provided in another side surface 103. As described above, since intake port 174 is provided at a position where it lies over one side surface 102 when overlaid portion 102a is stored, specifically, at a position in one side surface 102 close to top surface 104, exhaust port 171 is preferably provided in a portion of another side surface 103 close to bottom surface 105.

Taking into account operability, power switch 166 and operation button 167 are provided on top surface 104. Since bottom surface 105 or rear surface 107 is set as the installation surface, it is desirable not to provide an interface or an intake or exhaust port thereon.

(Construction of Slide Portion)

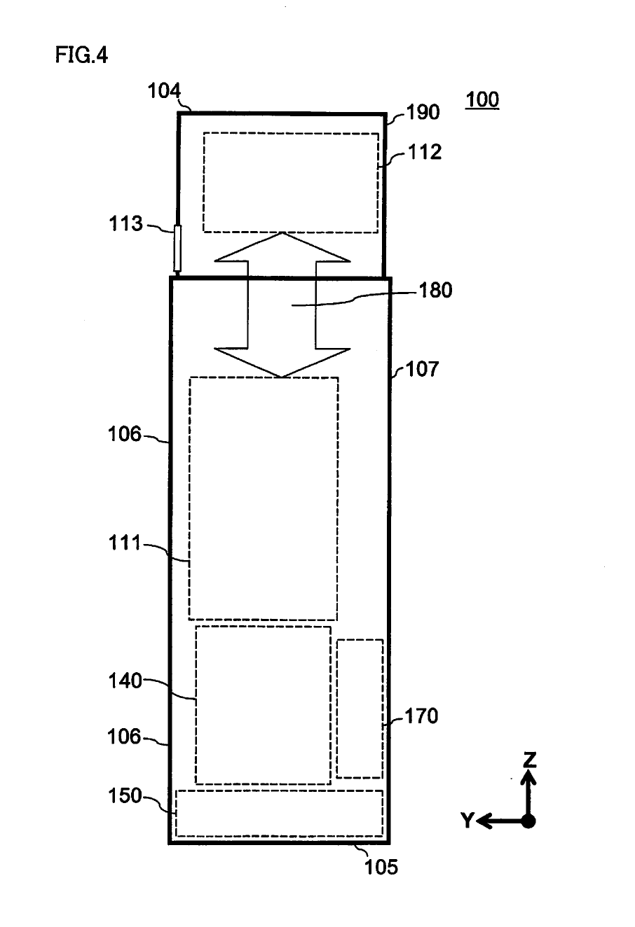

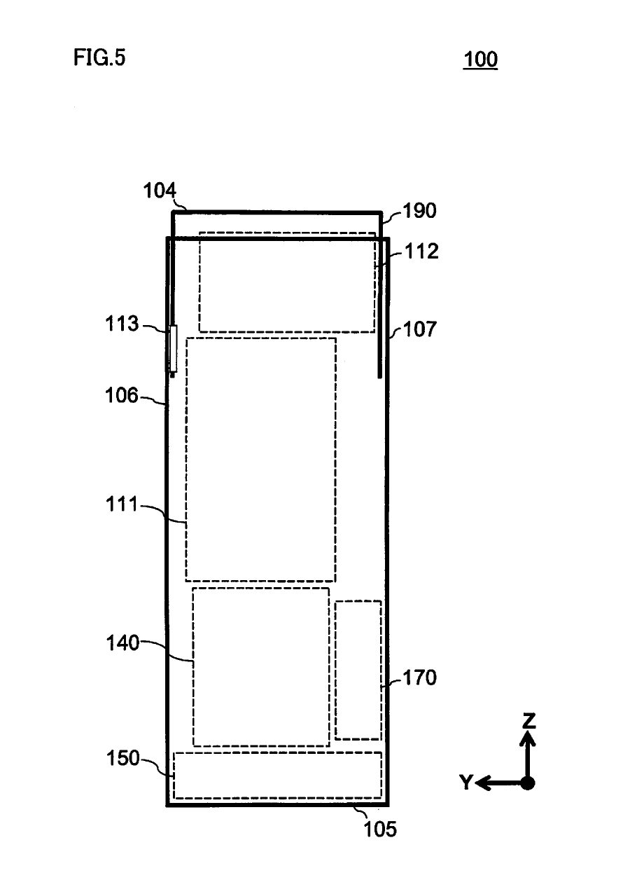

A construction of the slide portion of the projection-type image display apparatus according to the first embodiment will be described hereinafter with reference to the drawings. FIG. 4 is a diagram showing an internal construction when the projection-type image display apparatus projects imaging light and FIG. 5 is a diagram showing an internal construction when the slide portion is stored.

As shown in FIG. 4, when projection-type image display apparatus 100 projects imaging light, projection lens group 111 and aspherical mirror 112 should be distant from each other by a prescribed distance. This distance (a space 180) is a dead space when imaging light is not projected. Then, as shown in FIG. 5, when slide portion 190 is stored, slide portion 190 including aspherical mirror 112 and projection window 113 slides so as to be stored in space 180.

Thus, while projection-type image display apparatus 100 is not in use, a volume of projection-type image display apparatus 100 can be made smaller. In addition, since front surface 106 lies over projection window 113 and projection window 113 moves to a position hidden from the surface, projection window 113 can be prevented from being made dirty during storage. Since intake port 174 lies over one side surface 102 and thus it is closed, introduction of dust into projection-type image display apparatus 100 can be prevented.

[First Variation]

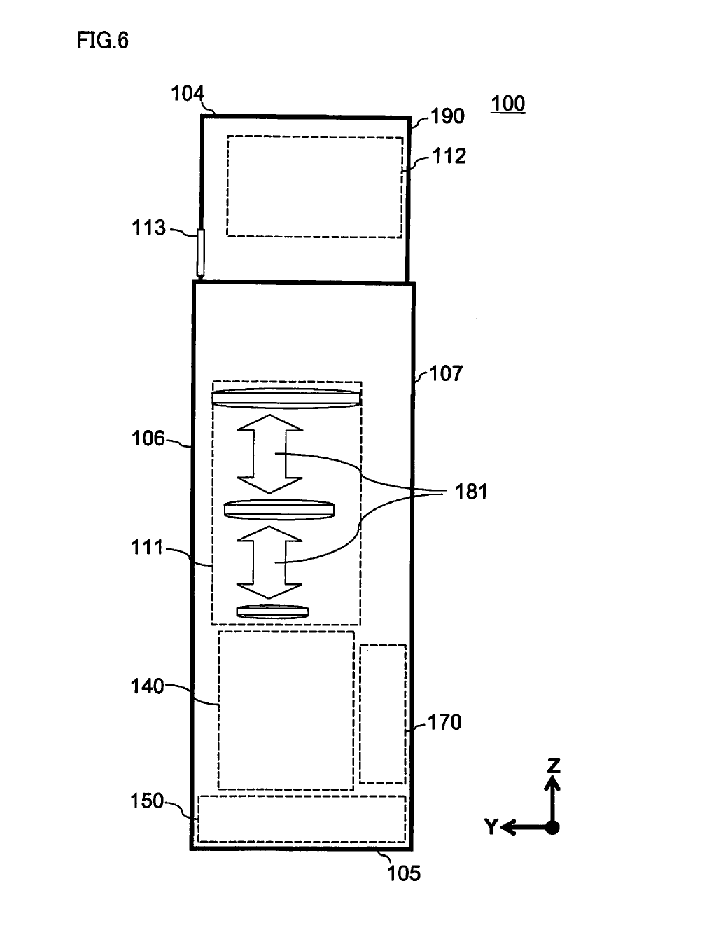

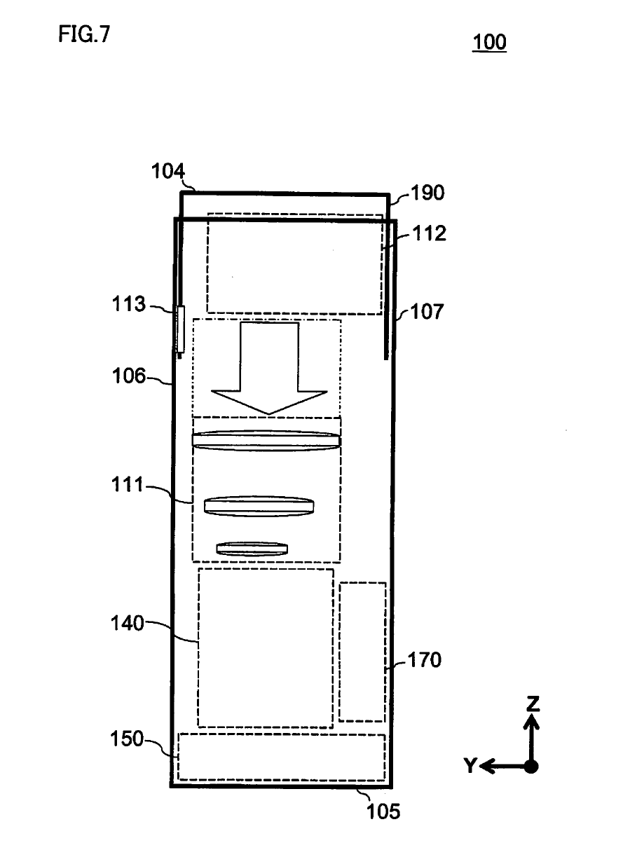

One variation of the slide portion according to the first embodiment will be described hereinafter with reference to the drawings. FIG. 6 is a diagram showing an internal construction when a projection-type image display apparatus projects imaging light and FIG. 7 is a diagram showing an internal construction when the slide portion is stored.

As shown in FIG. 6, when projection-type image display apparatus 100 projects imaging light, a plurality of lenses arranged in projection lens group 111 should be distant from one another by a prescribed distance. This distance (a space 181) is a dead space when imaging light is not projected. Then, as shown in FIG. 7, when slide portion 190 is stored, in coordination with sliding of slide portion 190, a distance between the lenses in projection lens group 111 is made as small as possible. As the dimension in the direction of the Z axis of projection lens group 111 is made smaller, slide portion 190 including aspherical mirror 112 and projection window 113 is stored in space 181.

[Second Variation]

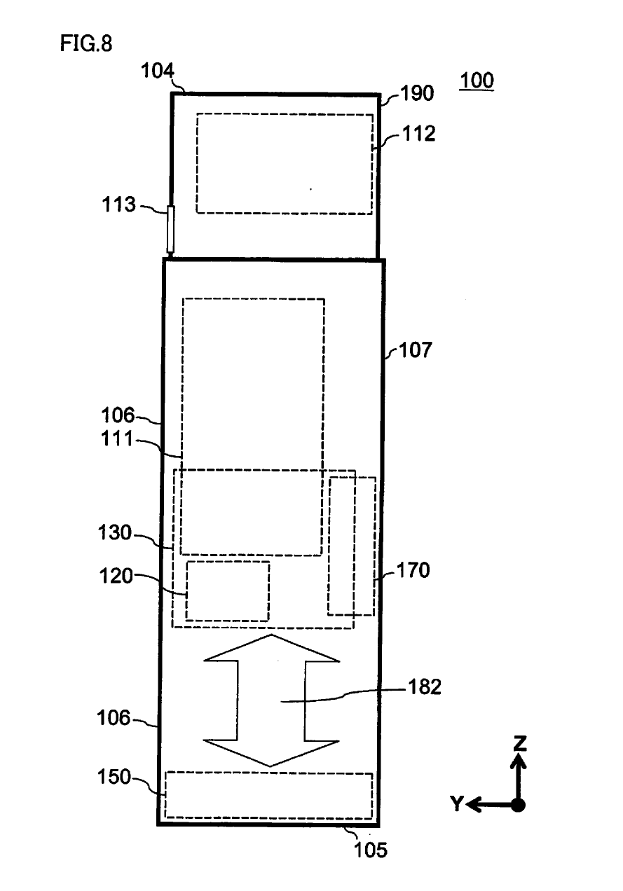

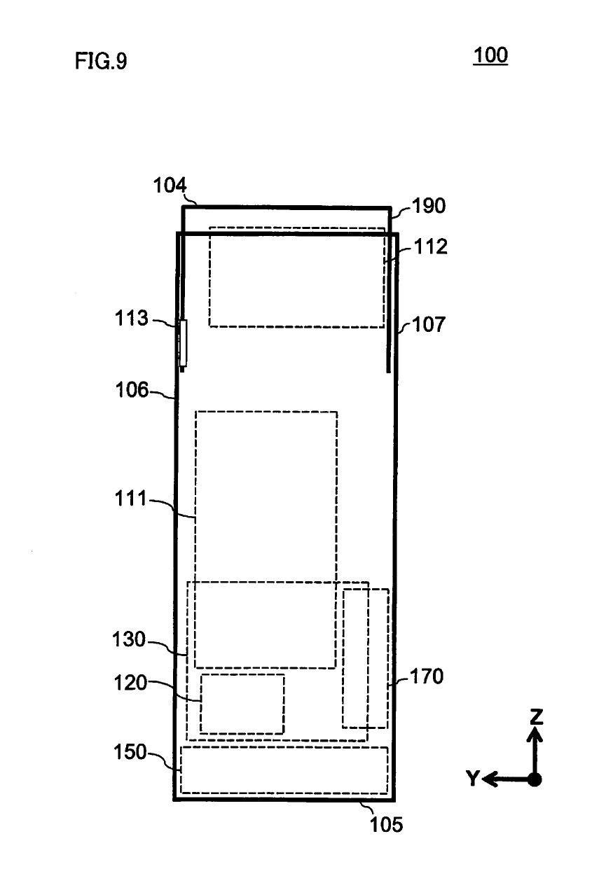

Another variation of the slide portion according to the first embodiment will be described hereinafter with reference to the drawings. FIG. 8 is a diagram showing an internal construction when a projection-type image display apparatus projects imaging light and FIG. 9 is a diagram showing an internal construction when the slide portion is stored.

As shown in FIG. 8, in the second variation, arrangement of DMD 120 and illumination portion 130 is changed and illumination portion 130 is arranged in a region of projection lens group 111 where a lens diameter is small. With the change in the position of illumination portion 130, cooling portion 170 should also be moved to a region corresponding to the positions of DMD 120 and illumination portion 130.

In projection-type image display apparatus 100 according to the second variation, when imaging light is projected, a space 182 is produced between DMD 120, illumination portion 130 (corresponding to image generation portion 140) and battery portion 150. Then, as shown in FIG. 9, when slide portion 190 is stored, projection lens group 111, image generation portion 140 and cooling portion 170 slide together with slide portion 190 including aspherical mirror 112 and projection window 113, so that they are stored in space 182.

### [Third Variation]

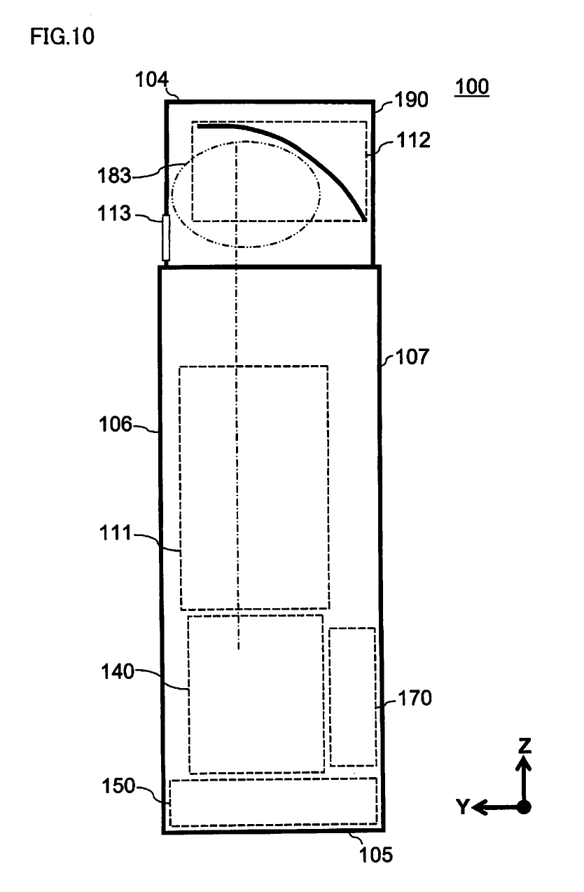

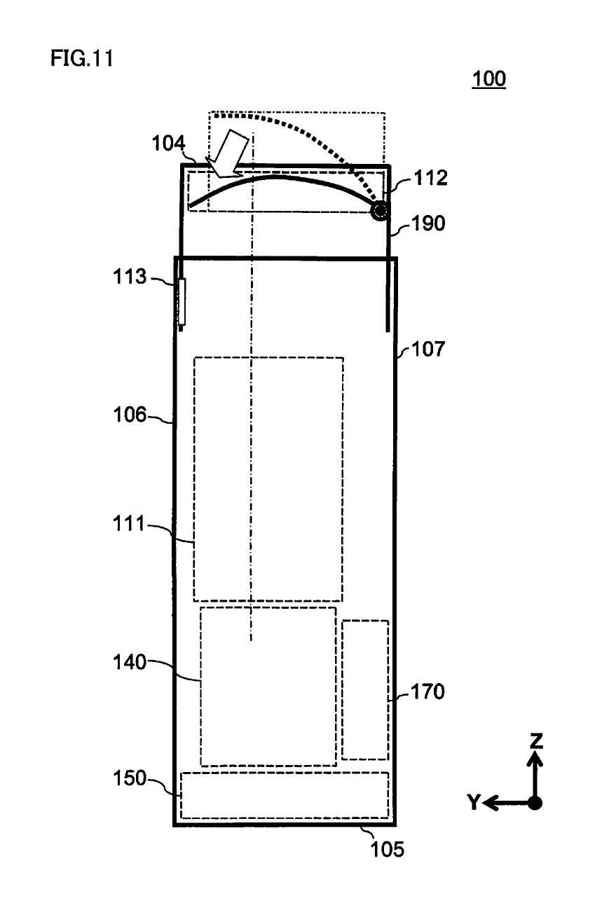

Another variation of the slide portion according to the first embodiment will be described hereinafter with reference to the drawings. FIG. 10 is a diagram showing an internal construction when a projection-type image display apparatus projects imaging light and FIG. 11 is a diagram showing an internal construction when the slide portion is stored.

As shown in FIG. 10, when imaging light is projected, aspherical mirror 112 is arranged on the side of rear surface 107 in an inclined manner with respect to an optical axis of projection lens group 111. Then, as shown in FIG. 11, when slide portion 190 is stored, in coordination with sliding of slide portion 190, aspherical mirror 112 is caused to pivot with one end of aspherical mirror 112 serving as a central axis. As aspherical mirror 112 pivots, the dimension in the direction of the Z axis of projection-type image display apparatus 100 is made smaller and slide portion 190 including projection window 113 is stored in a space 183.

[Other Variations]

Other than the examples above, a space may be provided between cooling portion 170 and illumination portion 130 by arranging cooling portion 170 below illumination portion 130 (image generation portion 140). In this case, slide portion 190 including projection portion 110 and image generation portion 140 is stored in this space.

A space may be provided between projection lens group 111 and DMD 120 by arranging DMD 120 perpendicular to the optical axis of projection lens group 111, without using prism block 121. In this case, projection portion 110 is stored in this space.

(Function and Effect)

In the first embodiment, projection-type image display apparatus 100 includes imaging light generation portion 140 for generating imaging light and aspherical mirror 112 for reflecting the imaging light emitted from the imaging light generation portion toward the projection surface. Projection-type image display apparatus 100 includes battery portion 150 for supplying electric power to imaging light generation portion 140 and battery portion 150 is provided at a position as distant as possible from aspherical mirror 112. Specifically, aspherical mirror 112 is provided in the uppermost portion and battery portion 150 is provided in the lowermost portion. Therefore, since heavy aspherical mirror 112 and battery 150 are provided at positions distant from each other, weight balance in the entire apparatus can be kept in equilibrium.

In addition, in the first embodiment, projection-type image display apparatus 100 includes imaging light generation portion 140 for generating imaging light, housing 101 for storing imaging light generation portion 140, and projection window 113 provided in housing 101, through which imaging light emitted from imaging light generation portion 140 passes. Housing 101 has slide portion 190 of which dimension in the direction of the Z axis varies. When imaging light is not projected, projection window 113 is stored in housing 101 by means of slide portion 190. Therefore, projection window 113 can be prevented from being flawed or made dirty.

### Second Embodiment

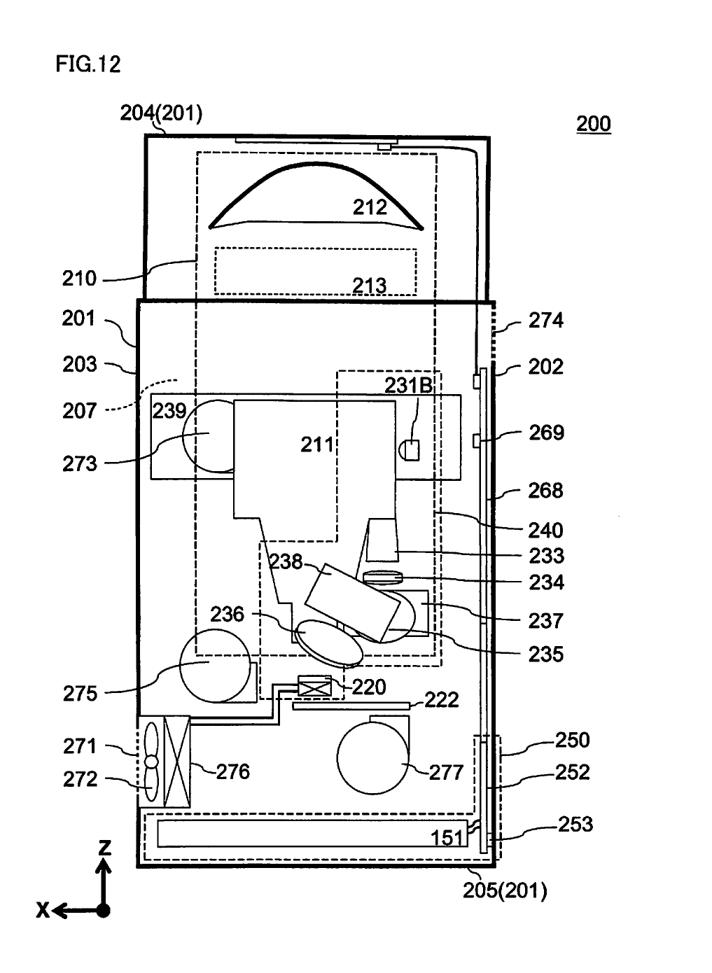

A construction of a projection-type image display apparatus according to a second embodiment will be described hereinafter with reference to the drawings. It is noted that description of a portion in the second embodiment the same as in the first embodiment is not provided. FIG. 12 is a front view showing a construction of the projection-type image display apparatus according to the second embodiment.

As shown in FIG. 12, it should be noted that a projection-type image display apparatus 200 is significantly different from the first embodiment in a construction of an image generation portion 240 and arrangement of a cooling portion 270. In addition, in the present embodiment, a state where a bottom surface 205 is set as an installation surface (a horizontal surface) and imaging light is projected on the horizontal surface such as a floor or a desk is referred to as a floor surface projection mode and a state where a rear surface 207 is set as an installation surface (a horizontal surface) and imaging light is projected on a vertical surface such as a screen or a wall is referred to as a wall surface projection mode.

In the present embodiment, LEDs 231R, 231G, 231B for emitting light of red, green and blue respectively, a dichroic prism 232 and a tapered rod 233 are arranged on the side of rear surface 207 relative to a projection lens group 211. In FIG. 12, these optical members are at positions hidden by projection lens group 211. Light emitted from tapered rod 233 is bent by lenses 234, 235, 236 and mirrors 237, 238 such that an optical path of combined light is bent in conformity with a space and an image is formed on a DMD 220.

DMD 220 is arranged perpendicular to an optical axis of projection lens group 211. Therefore, in the second embodiment, a prism block is not necessary. DMD 220 is irradiated with combined light guided from a direction at an acute angle with respect to the optical axis of projection lens group 211, by each optical member in an illumination portion 230. DMD 220 reflects imaging light modulated in accordance with an image input signal in this combined light toward projection lens group 211. A DMD control circuit 222 for controlling DMD 220 is arranged in the vicinity of DMD 220. In the second embodiment, DMD control circuit 222 is arranged on the rear surface side of DMD 220.

An LED control circuit 239 for controlling LED 231 is arranged in the vicinity of LED 231. In the second embodiment, LED control circuit 239 is arranged on the rear surface 207 side of an outer lens in projection lens group 211. Thus, LED control circuit 239 can be arranged in the vicinity of LED 231, as distant as possible from DMD control circuit 222.

A control circuit 268 in a control unit 260 has an inclination sensor 269. Inclination sensor 269 transmits information on detected inclination to control circuit 268. Control circuit 268 determines based on the received information, whether the user uses projection-type image display apparatus 200 in the floor surface projection mode in which bottom surface 205 is set as the installation surface or in the wall surface projection mode in which rear surface 207 is set as the installation surface. Control circuit 268 sends a control signal to DMD control circuit 222 in accordance with the determined projection mode. Though details will be described later, DMD control circuit 222 controls a size or an aspect ratio of an effective area of DMD 220 and vertical and horizontal directions of a projected image in accordance with the control signal in connection with the projection mode.

Cooling portion 270 is arranged in a region of projection lens group 211 on the side of another side surface 203. In the second embodiment, not only a sirocco fan 273 for cooling LED 231 but also a sirocco fan 275 and a heat sink 276 for cooling DMD 220 are arranged.

(Projection Mode Switching Function)

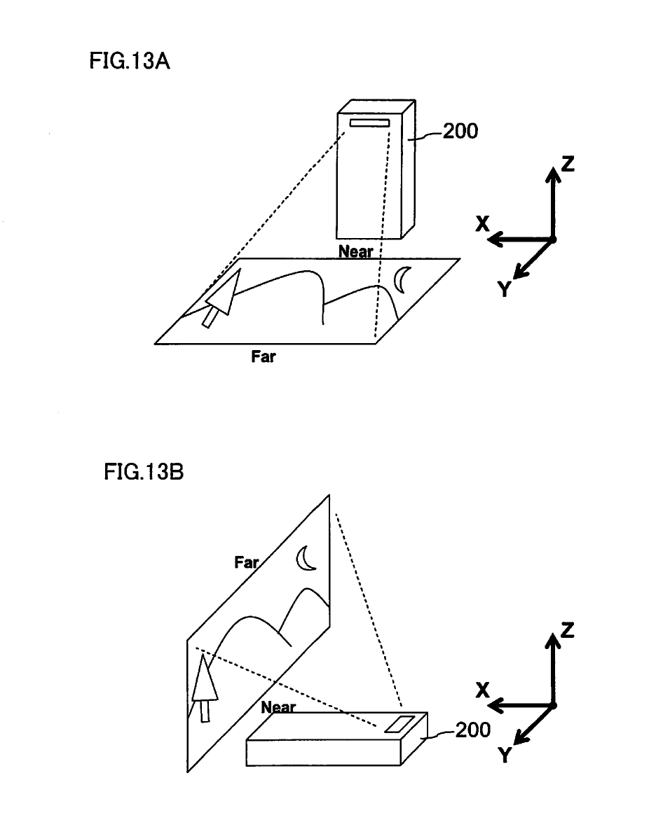

A function to switch between projection modes of the projection-type image display apparatus according to the second embodiment will be described hereinafter with reference to the drawings. FIGS. 13A and 13B are diagrams showing the projection modes of the projection-type image display apparatus according to the second embodiment, and FIG. 13A is a diagram showing the floor surface projection mode and FIG. 13B is a diagram showing the wall surface projection mode.

When projection-type image display apparatus 200 projects imaging light, projection-type image display apparatus 200 determines an installation surface based on information on inclination detected by inclination sensor 269. As shown in FIG. 13A, when bottom surface 205 is set as the installation surface, the user (the observer) observes a projected image from a far side (Far side) in many cases, and thus projection-type image display apparatus 200 projects an image with the Far side down. Specifically, when inclination sensor 269 determines that bottom surface 205 is set as the installation surface, control circuit 268 sends a control signal to DMD control circuit 222 such that the Far side is down.

On the other hand, as shown in FIG. 13B, when rear surface 207 is set as the installation surface, the user (the observer) observes a projected image with a proximate side (Near side) down, and hence projection-type image display apparatus 200 projects the image with the Near side down. Specifically, when inclination sensor 269 determines that rear surface 207 is set as the installation surface, control circuit 268 sends a control signal to DMD control circuit 222 such that the Near side is down.

Thus, simply by placing projection-type image display apparatus 200, an image is projected in an appropriate orientation and user's convenience is improved.

[First Variation]

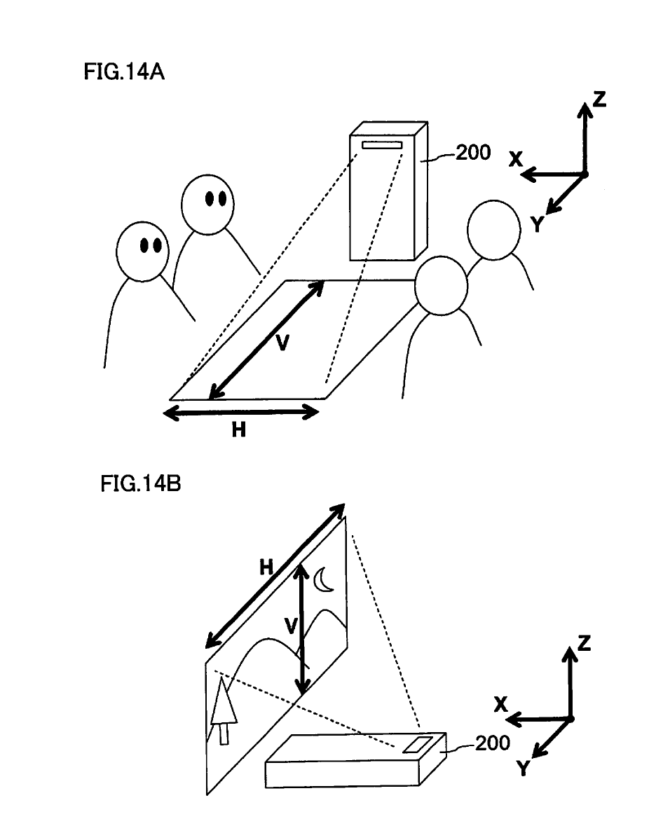

One variation of the function to switch between the projection modes according to the second embodiment will be described hereinafter with reference to the drawings. FIGS. 14A and 14B are diagrams showing the projection modes of the projection-type image display apparatus according to the first variation, and FIG. 14A is a diagram showing the floor surface projection mode and FIG. 14B is a diagram showing the wall surface projection mode. In the first variation as well, when projection-type image display apparatus 200 projects imaging light, it determines the installation surface based on information on inclination detected by inclination sensor 269.

As shown in FIG. 14A, when bottom surface 205 is set as the installation surface, a plurality of users (observers) may observe a projected image as they face each other with the projected image lying therebetween. Therefore, projection-type image display apparatus 200 projects an image such that an aspect ratio thereof is vertically long. Specifically, control circuit 268 sends a control signal to DMD control circuit 222 such that H:V is set to 3:4.

On the other hand, as shown in FIG. 14B, when rear surface 207 is set as the installation surface, the user (observer) observes a projected image from the front and hence projection-type image display apparatus 200 projects an image such that an aspect ratio thereof is horizontally long. Specifically, control circuit 268 sends a control signal to DMD control circuit 222 such that H:V is set to 4:3.

[Second Variation]

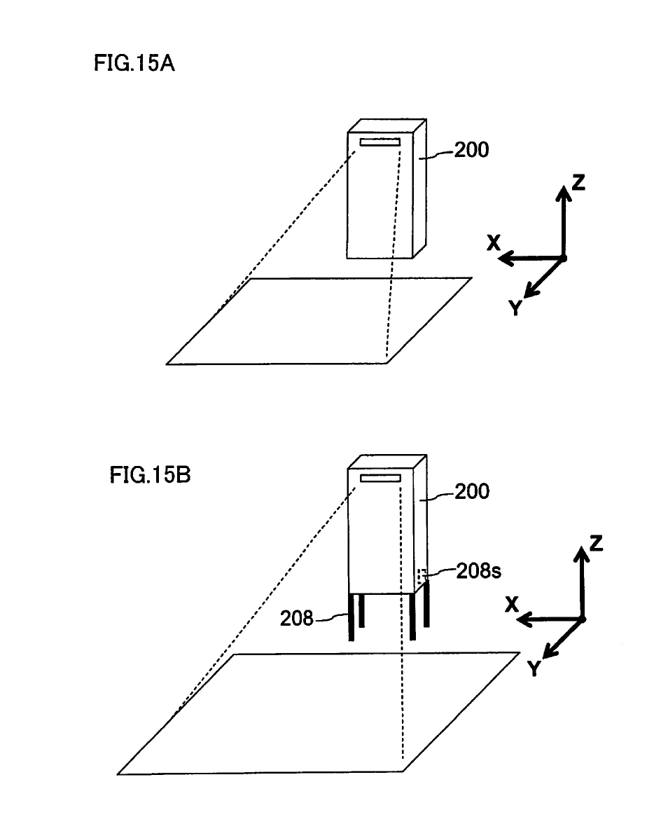

Another variation of the function to switch between the projection modes according to the second embodiment will be described hereinafter with reference to the drawings. FIGS. 15A and 15B are diagrams showing the floor surface projection modes of the projection-type image display apparatus according to the second variation, and FIG. 15A is a diagram showing a normal floor surface projection mode (hereinafter referred to as a normal mode) and FIG. 15B is a diagram showing a floor surface projection mode in which an area of a projected image is increased (hereinafter referred to as a magnified mode).

In the second variation, projection-type image display apparatus 200 has a leg portion 208 on bottom surface 205 and a leg portion sensor 208s for detecting a length of leg portion 208. Projection-type image display apparatus 200 estimates a projection distance based on information on the length of leg portion 208 detected by leg portion sensor 208s when it projects imaging light. Here, in the normal mode, a quantity of light from LED 231 required for such projection that luminance of a projected image attains to L in a region where the projected image has an area S is denoted as E.

As shown in FIG. 15B, leg portion 208 is extended from bottom surface 205 so as to increase a distance (projection distance) from a projection window 213 to the installation surface. Then, an area KS of the projected image in a magnified mode is greater than area S in the normal mode (KS>S). Here, if the quantity of light from LED 231 is E, luminance of the projected image in the magnified mode becomes lower than luminance L in the normal mode.

Then, when it is estimated that the magnified mode is set based on information from leg portion sensor 208s, control circuit 268 sends a control signal to LED control circuit 239 such that the quantity of light from LED 231 attains to KE (>E). Thus, luminance L in the normal mode is substantially equal to luminance KL in the magnified mode (L≈KL).

[Third Variation]

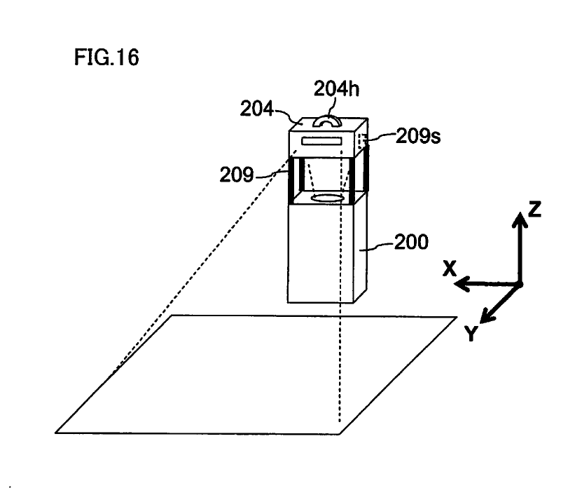

Yet another variation of the function to switch between the projection modes according to the second embodiment will be described hereinafter with reference to the drawings. FIG. 16 is a diagram showing a floor surface projection mode of a projection-type image display apparatus according to a third variation. In the third variation, difference alone from the second variation will be described.

In the third variation, projection-type image display apparatus 200 has in its upper portion, a neck portion 209 and a neck portion sensor 209s for detecting a length of neck portion 209. An aspherical mirror 212 is arranged in a portion above neck portion 209, and a distance between projection lens group 211 and aspherical mirror 212 is adjusted by extending and retracting neck portion 209. Projection-type image display apparatus 200 estimates a projection distance and a distance between projection lens group 211 and aspherical mirror 212 based on information on a length of neck portion 209 detected by neck portion sensor 209s when it projects imaging light.

A handle portion 204h for pulling up neck portion 209 is provided on top surface 204. In addition, a button (not shown) may be provided in handle portion 204h so that neck portion 209 can be extended when the button is pressed. Since neck portion 209 is not extended while the button is not pressed, handle portion 204h is useful also in carrying projection-type image display apparatus 200.

[Other Variations]

Other than the examples above, projection-type image display apparatus 200 may include an illuminance sensor. With the use of the illuminance sensor, brightness of an environment for use of projection-type image display apparatus 200 can be estimated. By controlling quantity of light E from a light source (LED 231) in accordance with the environment for use and area S of the projected image, not only an operation of projection-type image display apparatus 200 with low power consumption can be realized but also eye-friendly image can be provided to the user.

The examples above may also be combined. For example, when switching from a horizontally long projected image to a vertically long projected image is to be made, leg portion 208 is preferably adjusted to increase area S of a projection screen. In projecting a vertically long image, an effective display area of DMD 220 is transformed through signal processing by DMD control circuit 222. The effective display area of DMD 220 is thus made smaller and area S of the projection screen is made smaller. Then, by extending leg portion 208 so as to increase a projection distance, area S can be maintained.

(Function and Effect)

In the second embodiment, projection-type image display apparatus 200 includes imaging light generation portion 240 for generating imaging light and aspherical mirror 212 for reflecting imaging light emitted from imaging light generation portion 240 toward the projection surface. Projection-type image display apparatus 200 includes a battery portion 250 for supplying electric power to imaging light generation portion 240 and battery portion 250 is provided at a position as distant as possible from aspherical mirror 212.

In addition, projection-type image display apparatus 200 further includes cooling portion 270 for cooling imaging light generation portion 240, and specifically an axial fan 272, sirocco fan 275, heat sink 276, and a sirocco fan 277 in cooling portion 270 are also preferably provided at positions close to bottom surface 205, as distant as possible from aspherical mirror 212. Thus, since cooling portion 270 heaviest but aspherical mirror 212 and battery portion 250 is provided at a position distant from aspherical mirror 212, weight balance in the entire apparatus can be kept in equilibrium. Moreover, battery portion 250 and cooling portion 270 are provided in proximate to each other at positions close to the bottom surface. Therefore, even if the bottom surface has a small area, the projection-type image display apparatus can be installed in a stable manner.

Further, in the second embodiment, projection-type image display apparatus 200 includes inclination sensor 269, leg portion sensor 208s and neck portion sensor 209s for detecting a state of the apparatus itself with respect to the projection surface, and control unit 260 for controlling a state of imaging light in accordance with the detected state. Therefore, projection-type image display apparatus 200 determines a state of the apparatus itself, specifically, the installation surface or a projection distance, and projects an image in a state considered as easiest for the user to make observation (for example, an orientation, brightness or the like), and thus user's convenience can be improved.

### Other Embodiments

The present invention has been described with reference to the embodiments above, however, discussions and drawings forming a part of this disclosure are not to be understood to limit the present invention. Various alternative embodiments, examples and operation techniques will be apparent to a person skilled in the art based on this disclosure.

Specifically, though the housing has been described as having a substantially parallelepiped shape having six surfaces, the shape of the housing is not limited to a parallelepiped but a shape with importance being placed on design may be adopted. In addition, a vertex or a side of the parallelepiped may be rounded, or a protrusion or a recess may be provided in a central portion or around the center of gravity. If a protrusion or a recess is provided in the central portion or around the center of gravity, it facilitates carrying.

Though an LED has been described by way of example of a light source, the light source is not limited to the LED, but a laser light source may also be used as a solid-state light source and a high-pressure mercury-vapor lamp, a xenon lamp or the like may also be used as a lamp light source. Though a DMD has been described by way of example of a light modulation element, a transmissive, a semi-transmissive or a reflective liquid crystal panel or the like can also be used.

Though a construction in which a nickel metal hydride battery is fixed to the bottom surface of the projection-type image display apparatus has been described by way of example of the battery portion, the nickel metal hydride battery may be connected to a battery control unit through a connector so that it can be replaced with another battery. In addition, the battery control unit may carry out control such that electric power can directly be supplied from the commercial power supply to each portion through the power supply connector. Thus, even when a state of charge of one battery is low, it can be replaced with another battery or electric power can be supplied from the commercial power supply, and thus an image can be displayed for a long time.

Though turn-on of the projection-type image display apparatus has been described by referring to a feature of pressing the power switch, the slide portion may function as the power switch. Namely, the projection-type image display apparatus may be constructed such that it is turned on as the slide portion is drawn out and imaging light can be emitted through the projection window and it is turned off as the slide portion is stored in the housing.

Though the description has been given assuming that the aspect ratio of a projected image is set to H:V=4:3, the aspect ratio may naturally be set to H:V=16:9.

Though the description has been given by referring to a construction in which an operation button or a switch is arranged on the top surface or the side surface of the housing, the operation may be performed by using a remote controller. In this case, a light reception portion for receiving a signal from the remote controller is preferably arranged in an upper portion of the front surface or the side surface (on the side of the aspherical mirror). If the light reception portion is arranged in a portion located in an upper portion in use of the projection-type image display apparatus, a signal will not be cut off.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A projection-type image display apparatus which projects imaging light on a projection surface, comprising:
an imaging light generation portion which generates said imaging light;
a housing which stores said imaging light generation portion; and
a passage region provided in said housing, through which said imaging light emitted from said imaging light generation portion passes,
said housing having a movable portion of which dimension in at least one direction varies, and
said passage region being stored in said housing by means of said movable portion while said imaging light is not projected.

2. The projection-type image display apparatus according to claim 1, further comprising an intake port or an exhaust port through which air for cooling said imaging light generation portion is taken in or exhausted, wherein
at least one of said intake port and said exhaust port is closed by said movable portion while said imaging light is not projected.

3. The projection-type image display apparatus according to claim 1, further comprising a mirror which reflects said imaging light emitted from said imaging light generation portion toward said projection surface, wherein
said mirror is provided in said movable portion.

4. The projection-type image display apparatus according to claim 1, wherein
said movable portion extends and retracts as it slides in a dimension of height of the apparatus, and
a mirror which reflects said imaging light emitted from said imaging light generation portion toward said projection surface and condenses that light and the passage region provided near a position where said mirror condenses said imaging light are provided in said movable portion.

5. The projection-type image display apparatus according to claim 1, comprising:
a mirror which reflects said imaging light emitted from said imaging light generation portion toward said projection surface; and
a battery portion which supplies electric power to said imaging light generation portion, wherein
said mirror and said battery portion are arranged with said passage region lying therebetween.

6. The projection-type image display apparatus according to claim 1, comprising:
an inclination sensor which senses inclination of said housing with respect to an installation surface; and
a control unit which controls a state of imaging light based on information on inclination detected by said inclination sensor.
